(19) United States
(12) Patent Application Publication
(10) Pub. No.: US 2026/0135963 A1
(43) Pub. Date: May 14, 2026

(54) METHOD FOR MARKING A PRINTED PRODUCT WITH A MARK, USE OF A MARK FOR TRACING BACK A PRINTED PRODUCT BEARING THE MARK, AND MARKED PRINTED PRODUCT

(71) Applicant: FLYERALARM Industrial Print GmbH, Marktheidenfeld (DE)

(72) Inventors: Michael DEML, Neumarkt (DE); Jan KRISCHIK, Veitshöchheim (DE)

(21) Appl. No.: 19/111,751

(22) PCT Filed: Sep. 8, 2023
(86) PCT No.: PCT/EP2023/074730

§ 371 Date: Mar. 13, 2025

(30) Foreign Application Priority Data
Sep. 14, 2022 (DE) 10 2022 123 475.4

(51) Int. Cl. H04N 1/00; G06F 3/12; G06F 21/60

(52) U.S. Cl. CPC H04N 1/00846; G06F 3/1222; G06F 3/1238; G06F 21/602; G06F 21/608

(57) ABSTRACT

The invention relates to a method for marking a printed product (20) with a mark (14), the method comprising the following steps:
a. acquiring a printed-product raw template (10);
b. analyzing the printed-product raw template (10) for at least one characteristic property of the printed-product raw template (10) to determine at least one suitable section (11), the at least one characteristic property having a nature and a manifestation;
c. selecting at least one suitable section (11) and identifying coordinates of the selected section (12);
d. creating a mark (14) in consideration of the manifestation of the at least one characteristic property in the selected section (12) and storing the nature of the at least one characteristic property, the manifestation of the at least one characteristic property, the mark (14) and/or the coordinates of the selected section (12) with reference to a print job;
e. producing a printed-product template (13) by modulating the selected section (12) of the printed-product raw template (10) as a function of the mark (14); and
f. producing and obtaining a printed product (20) according to the printed-product template (13).

The invention relates to a method for marking a printed product with a mark according to claim 1, a use of a mark for tracing back a printed product bearing the mark according to claim 15, and a marked printed product according to claim 21.

The prior art discloses the marking of printed products by incorporating a mark in the print template. The simplest way is to overlay the print template with the previously defined mark. However, this approach has the disadvantage that the mark remains visible to the naked eye and thus disturbs the appearance of the design of the printed product.

Another known method consists in storing unwanted printing errors that occur in the printed product during the printing process with reference to the print job. However, the disadvantage of this method is that the errors may not be reproducible on a large scale and must first be laboriously tracked down in the printed product and then stored. Another laborious search of the printed product has to be carried out when checking it.

Another method known in the prior art is to vary the printing dots forming the printed product by shifting their position or changing their shape. However, the disadvantage of this method is that it requires a custom-made printing press or complex reprogramming of the software for operating the printing press.

There is therefore a great need for a method of marking printed products with a mark in which the mark does not interfere with the design of the printed product, can be incorporated easily and quickly, in particular without modifying the printing press or the software controlling the printing press, and can also be found in an easy, fast and reliable manner. The object of the invention is to provide a method for creating such a mark, the use of such a mark, and a printed product with such a mark that overcomes the disadvantages mentioned above.

This object is attained in a surprisingly simple but effective manner by a method for marking a printed product with a mark according to the teaching of independent claim 1, a use of a mark for tracing a printed product bearing the mark back to a print job according to the teaching of independent claim 15, and a marked printed product according to the teaching of independent claim 21.

The invention proposes a method for marking a printed product with a mark, the method comprising the following steps:
a. acquiring a printed-product raw template;
b. analyzing the printed-product raw template for at least one characteristic property of the printed-product raw template to determine at least one suitable section, the at least one characteristic property having a nature and a manifestation;
c. selecting at least one suitable section and identifying coordinates of the selected section;
d. creating a mark in consideration of the manifestation of the at least one characteristic property in the selected section and storing the nature of the at least one characteristic property, the manifestation of the at least one characteristic property, the mark and/or the coordinates of the selected section with reference to a print job;
e. producing a printed-product template by modulating the selected section of the printed-product raw template as a function of the mark; and
f. producing and obtaining a printed product according to the printed-product template.

The basic idea of the invention is to first select a section that is as suitable as possible for a mark and then to adapt the mark to the selected section. This makes it possible to adapt the mark to the section in such a manner that the mark does not disturb the appearance of the print job by impairing the design while being easily found and read, if necessary with the help of aids. Specifically, the difference between the proposed method and the prior art is that it does not involve defining a mark in advance and then attempting to incorporate it into the design as well as possible or relying on randomly introduced marks, but rather that the design is searched for suitable sections for a mark and then a mark is selected for the suitable section.

In the context of the invention, it has further been recognized that the designs usually have a large variety of suitable locations. It has further been recognized that the suitable sections for a mark in each design have individual coordinates in a sufficiently high number of cases according to the invention. The individual coordinates make it possible to introduce a mark that is small in size and to distinguish the print jobs using the coordinates of the section with the mark or of the sections with the marks. In the method according to the invention, the marks can even be identical since the print jobs can be distinguished from one another based on the differing coordinates of the selected section or the selected sections with a mark, which result from the different positions of the suitable sections and/or the selected sections. The sections preferably have a maximum extent of 2000 μm, 1900 μm, 1800 μm, 1700 μm, 1600 μm, 1500 μm, 1400 μm, 1300 μm, 1200 u μm, 1100 μm, 1000 μm, 900 μm, 800 μm, 700 μm, 600 μm, 500 μm, 400 μm, 300 μm or 200 μm.

In step a., a printed-product raw template is acquired. The acquiring can be done by creating the printed-product raw template, for example by photographing or assembling it in an image-processing program. It is also conceivable that the acquiring is done by digitizing a design, for example by scanning or photographing a template. Furthermore, it is conceivable that the printed-product raw template is downloaded, loaded from a data carrier, digitally transmitted, digitally sent, digitally copied or digitally provided in some other manner. It might also conceivable that a digital format conversion is carried out. However, the method according to the invention is not limited to execution on a computer system. It is also conceivable that the acquiring is carried out by analog provision, for example by presenting a printout, a screen printing template, a printing plate or a negative showing the design. The acquiring can also mean enlarging the design or sections of the design.

In step b., the acquired printed-product raw template is analyzed for at least one characteristic property of the printed-product raw template to determine at least one suitable section. The suitability of a section is determined by the manifestation of the at least one characteristic property. That is, a section is suitable if the manifestation of the characteristic property in this section fulfills one or more previously determined conditions. The term “characteristic property” refers to a property which is essential to the printed-product raw template and which has a nature and a manifestation that allows it to be traced back to the printed-product raw template directly or indirectly. The term “nature of the at least one characteristic property” refers to a general characteristic, in particular a characteristic that describes an image. The term “manifestation of the at least one characteristic property” refers to the specific value of a characteristic. A manifestation can therefore always be associated with at least one nature of a characteristic property. Characteristic properties can also be composed of other characteristic properties. Examples of natures of the at least one characteristic property, manifestations of the at least one characteristic property and conditions for the manifestation for determining the suitability of the characteristic property are given elsewhere. Preferably, at least one characteristic property is acquired; more preferably, at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 or more identical or different characteristic properties are acquired. The printed-product raw template is analyzed by checking sections of the printed-product raw template as to whether the manifestation of the characteristic property in this area of the section satisfies the previously determined condition(s). The at least one suitable section is determined by establishing that the manifestation of the characteristic property in this area of the suitable section satisfies the previously determined condition(s). It is conceivable that only one suitable section is determined and then the analysis is terminated. However, it is preferable to continue the analysis and thus obtain at least two, at least three, at least four, at least five, at least six, at least seven, at least eight, at least nine, at least ten, at least 15, at least 20, at least 25, at least 30, at least 35, at least 40, at least 45, at least 50, at least 55, at least 60, at least 65, at least 70, at least 75, at least 80, at least 85, at least 90, at least 95 or at least 100 suitable sections.

In step c., at least one of the suitable sections is selected, and the coordinates of the selected section are identified. The method of selection is arbitrary. Possible selection procedures are described elsewhere. The coordinates can also be identified in any manner, but preferably they are identified in relation to the total size of the printed-product raw template. This means that the x-coordinate is measured and the measured value is then divided by the total width in the x-direction of the printed-product raw template, and the y-coordinate is measured and this value is then divided by the total height in the y-direction of the printed-product raw template. This yields values that are normalized to the dimensions of the printed-product raw template. Normalized values are advantageous since this means that the coordinates are independent of any enlargement of the printed-product raw templates. The lower left corner of the printed-product raw template or the center of the printed-product raw template is preferably used as the reference point for the coordinates. The point at which the mark is introduced in a selected section in a later step is preferably used as the reference point for the selected section.

In the subsequent step d., a mark is created in consideration of the manifestation of the at least one characteristic property in the selected section. Preferably, the mark is created in such a manner that it stands out from the selected section. The mark itself can carry information, that is, the mark has an inherent readable value. It is also conceivable that the mark alone serves to mark the selected section and the coordinates associated with the selected section. In this manner, as described elsewhere, the suitable section on a printed product can be identified as a selected section in a later process and the coordinates of the selected section can be determined. The nature of the at least one characteristic property, the manifestation of the at least one characteristic property, the coordinates of the selected section and/or the mark are then stored with reference to a print job. It is particularly preferred that at least the coordinates of the mark are stored. Storing preferably means storing in a database; other methods of storage, such as a collection of files, are also conceivable. The storage is done in such a manner that when a search is made for the nature of the at least one characteristic property, the manifestation of the at least one characteristic property, the coordinates and/or the mark, the associated print job is produced. The storage of the mark concerns the storing of the nature, that is, the manifestation, of the mark and/or of the information contained in the mark. In the context of the invention, it has been recognized that the suitability of characteristic properties for the method according to the invention or the use according to the invention depends to a large extent on the design. Hence, storing the nature and/or the manifestation of the at least one characteristic property can simplify the subsequent use, which is described elsewhere. This is made possible in particular because a preselection of the print jobs is made on the basis of the nature and/or the manifestation of the at least one characteristic property. It is also conceivable that the printed-product raw template is first analyzed for a plurality of characteristic properties and at least one characteristic property, preferably multiple characteristic properties, thereof are selected in step b., and the nature and/or the manifestation of the selected characteristic property is stored in step b. or in step d.. Preferably, the selection is made on the basis of suitability and/or on the basis of a previously defined hierarchy of the characteristic properties.

In step e., a printed-product raw template is produced by modulating the selected section of the printed-product raw template as a function of the mark. In other words, the manifestation of the characteristic property in the selected section is at least partially modulated in such a manner that it now bears the mark. Preferably, the mark is introduced in the center of the selected section by modulation. Examples of modulation are described elsewhere. It is conceivable that the section is selected on the basis of multiple characteristic properties, while the mark relates only to one of the characteristic manifestations and therefore only one of the characteristic manifestations is modulated. By modulating the printed-product raw template, the printed-product template is obtained.

In step f., the printed product is generated using the printed-product template, and the printed product is subsequently obtained. The printed product now shows the design in which the mark has been incorporated since the design has been produced according to the modulated printed-product raw template, which is now the printed-product template. It should be noted that the suitability of a suitable section is related to the planned modulation process and the manner of the production of the printed product. This means that a section that is particularly suitable for a first modulation process and/or for a first manufacturing process is not necessarily suitable for another modulation process and/or for another manufacturing process.

The term “design” refers to the artistic design of the printed-product raw template or the printed-product template.

The term “acquiring” refers to the provision of the printed-product raw template for further processing in a format suitable for the method.

The term “information of the mark” refers to information that is stored in the mark and can be read from the mark. The selection of the information is adapted to the manifestation of the characteristic property of the section, but can also have other influences.

The term “print job” refers to the commissioning of the production of one or more printed products that is/are provided with a uniform design specified in a printed-product raw template.

The term “modulate” refers to the at least localized modification of the manifested property. This can be done digitally, for example using suitable image processing programs, or analogously, for example by modifying a printing plate.

By selecting the mark as a function of the manifestation of the at least one characteristic property of the selected sections, it becomes possible to insert the mark inconspicuously, invisibly and/or in a manner that does not disturb the aesthetics of the design, while at the same time enabling tracing the mark back to a print job by storing the coordinates and/or the information of the mark. It has been recognized that even with identical information and design of the mark and identical coordinates, the reduction from a large number of print jobs to a few print jobs is already extremely helpful.

Advantageous embodiments of the invention, which can be realized individually or in combination, are set forth in the dependent claims.

In a preferred embodiment of the method, the nature of the at least one characteristic property is monochromaticity, hue, value (brightness), saturation, regularity, pixel density, potential dot density, frequency space and/or contrast. The natures listed above have to meet certain conditions in order to create a suitable mark that can be easily found and incorporated by simple means; the conditions may depend on the nature of the mark and the manner in which it is incorporated.

Monochromaticity means that the suitable section is unicolor. That is, the section preferably has a single color, if at all possible. A color can be described by three color characteristics, which represent the hue, the value (brightness) and the saturation. These three color characteristics form what is referred to as the HSV color space, where H stands for hue, S for saturation and V for value (brightness). The characteristic property can therefore refer to one, two or all of these color characteristics. From a practical point of view, which results from four-color printing, the colors yellow, magenta, cyan and black are of particular importance. If the printed product is not white in its base color, then an additional color, namely the color white, is necessary for printing. If a suitable section has one of these base colors, then, in four-color printing, it is produced with only one of the colors. This simplifies the introduction of a suitable mark. The printing color black corresponds to a value (brightness) of 0 %, the printing color white, if present, to a value (brightness) of 100 %. In four-color printing, value (brightness) and saturation result from the mixing ratio of the individual colors, in particular the addition of the color black, and the size of the individual dots. The larger the dot, the more intense the color will be to the viewer. Pixel density describes the number of dots per unit length that make up a digital image. The manifestation of pixel density is typically between 70 ppi and 350 ppi. In order to make it practically possible for a mark to be placed in a suitable section, this section must have a sufficiently high number of pixels if the printed-product raw template is in digital form. This analogously applies to the printed dots in four-color printing. Here, too, the suitable section must have or be able to have a sufficient number of dots. Normally, printed products have a dot density manifestation of 300 dpi. If the printed product is white, no dots are introduced in a white section. However, it is conceivable to introduce a colored mark in a purely white section. It is also conceivable to introduce a mark in a regularly structured section by deliberately disrupting the regularity. Regularly structured sections may include, in particular, but are by no means limited to, stenographic elements, wherein it is conceivable that the mark in step d. is created by changing the size, the spacing and/or the font of one or more stenographic elements. The frequency space relates to the result of a frequency analysis, for example a windowed Fourier transform. The mark can then be created by manipulating one or more frequencies. The advantage of this is that the mark is distributed across the entire section and is therefore invisible. Furthermore, it is conceivable that the manifestation of the at least one characteristic property in the frequency space can be partially or completely stored. In the case of partial storing, particularly characteristic subsets can be stored. This leads to a reduction in the amount of data, which accelerates the method and the use described elsewhere. Sections that stand out from the rest of the printed product raw template due to their contrast are particularly suitable sections, as they are easy to find.

It is conceivable that the suitability of the suitable sections in step b. is reflected in a limitation of a maximum deviation of the manifestation of the at least one characteristic property from a mean value of the manifestation of the at least one characteristic property across the entire area of the section. In other words, this means that the manifestation of the characteristic property is limited across the entire suitable section. This means that while the manifestation of the at least one characteristic property may exhibit a certain deviation, this deviation is small according to the invention. The deviation can preferably be determined as a percentage of the maximum value of the characteristic property. In a particularly preferred manner, the maximum deviation is 0.1 %, 0.2 %, 0.3 %, 0.4 %, 0.5 %, 0.6 %, 0.7 %, 0.8 %, 0.9 %, 1 %, 1.5 %, 2 %, 2.5%, 3 %, 3.5 %, 4 %, 4.5 %, 5 %, 5.5 %, 6 %, 6.5 %, 7 %, 7.5 %, 8 %, 8.5 %, 9 %, 9.5 % or 10 % based on the maximum value of the characteristic property or the characteristic properties. The maximum value of a characteristic property is the value with the largest absolute number. Based on the hue, this is 100 in the CMYK color model, for example, the CMYK color model being the subtractive color model consisting of the colors cyan (C), magenta (M), yellow (Y) and black (K for key), on which four-color printing is based. The values, which can range from 0 to 100, are directly related to the dimensions of the color dots that make up the design in four-color printing. A value of 0 corresponds to a non-existent dot and a value of 100 corresponds to the maximum size of this dot. It should be noted that if a value is sufficiently high, the dots of a color will merge. In the RGB-255 color model, the maximum value for the respective primary colors is 255, the RGB color model being an additive color model consisting of the three primary colors red, green and blue for, in particular, digital transmission of designs to screens or monitors. In the HSV color space, which takes into account the color characteristics and is described elsewhere, the maximum value for the value (brightness) and the saturation is 100 % each and 360° for the hue; it should be noted that the hue can exceed 360° to 0°. For example, the mean value can be 0°and the limitation then lies between 355° and 5°.

For example, the mean value of the manifestation in a section of the characteristic property is (0, 0, 50, 0) in the CMYK color model. The exemplary value of (0, 0, 50, 0) corresponds to a medium-pale yellow. The limitation of the maximum deviation is 5 percentage points for the yellow hue. The present section is therefore suitable if the section only contains dots that have a Y-value in the range of 45 and 55. It is conceivable that the other colors in the CMYK color model are unlimited or also subject to a limitation of a maximum deviation in terms of manifestation.

Moreover, it is advantageously conceivable that the selection of the at least one suitable section in step c. is random or takes place according to a rule. The advantage of a random selection is in particular that the coordinates of the selected section differ with very high probability from the coordinates of other selected sections of the printed-product raw templates of other print jobs and therefore the individual print jobs are easier to tell apart based on the coordinates alone. Using a rule when selecting the suitable sections makes it easier to find the mark, as described elsewhere, in order to trace the coordinates and/or the mark back to a print job when using the mark to trace a printed product bearing the mark back to a print job. The rule can concern both an initial selection, such as “first select the suitable section that is closest to the center of the printed-product raw template,” but also the manner in which the subsequent suitable sections are selected if more than one suitable section is selected. The rule can include a fixed or predetermined sequence of steps or can be related to the already selected sections, such as “select the suitable section that has the greatest distance to all previously selected sections in total.”

In a preferred embodiment, between 2 to 40 suitable sections are selected in step c. In principle, any number of suitable sections can be selected in step c. The larger the number of selected sections, the more likely it is that the constellation of all coordinates is unique. However, a too large number of suitable sections being marked can disrupt the appearance of the design and slow down and/or complicate the method and the use of the mark for tracing back, as described elsewhere. Within the scope of the invention, it has been found that the selection of 2 to 40 suitable sections leads to a satisfactory result. In a particularly preferred manner, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 suitable sections are selected in step c..

It is also advantageous if the mark is selected in such a manner in step d that its extent on the printed product is not greater than 200 μm, in particular not greater than 100 μm. The human eye cannot recognize a mark with such a small extent, meaning the mark remains invisible without aids and does not disturb the design of the printed product. The only way in which a disturbance can occur is by an insufficient distance of the individual marks; however, this can be prevented by a suitable rule or a random selection of the sections, as described elsewhere, and/or by limiting the selection to 2 to 40 suitable sections. The extent on the printed product is preferably not greater than 200 μm, not greater than 190 μm, not greater than 180 μm, not greater than 170 μm, not greater than 160 μm, not greater than 150 μm, not greater than 140 μm, not greater than 130 μm, not greater than 120 μm, not greater than 110 μm, not greater than 100 μm, not greater than 90 μm, not greater than 80 μm, not greater than 70 μm, not greater than 60 μm or not greater than 50 μm.

In a particularly preferred embodiment of the method, the mark is created in step d by inverting the manifestation of the at least one characteristic property at least in a localized manner. The term “inverting” refers to the reversal of the color. For individual colors, inverting means mapping the colors to their complementary colors, which are known to the person skilled in the art. For the CMYK color model, this means that the individual values of the colors are subtracted from the maximum value described elsewhere. However, it is also conceivable that only one, two or three of the four colors of the CMYK color model is/are inverted. In the RGB color space, this means that the individual values of the colors are subtracted from the value 255. Again, it is conceivable that only one or two of the primary colors is/are inverted. Since the color value in the HSV color space is represented as an angle, the hue scale being closed, the color value is rotated by an angle of 180° for an inversion. The color saturation and the value (brightness) are inverted by subtraction from their maximum value of 100 %

The term “localized” refers to a partial, in particular smaller, area of the selected section.

In an alternative, preferred embodiment, the mark is formed in step d. by the at least localized assignment of an extreme value of the at least one characteristic property. Extreme values are understood to mean the maximum and minimum values. In the CMYK color model, the extreme values are 0 and 100. In the RGB color space, the extreme values are 0 and 255. For the hue in the HSV color space, extreme-value assignment is not possible due to the closed representation of the color value. However, the extreme values 0 % and 100 % can be assigned to the color saturation and the value (brightness). Assigning an extreme value of the at least one characteristic property is advantageous because this makes each section a suitable section if its color or hue is limited to a maximum deviation from a mean value. Depending on which side of the center of the value scale the mean value is located, a mark that can be easily found can be created by assigning the extreme value on the other side of the center of the value scale.

In another preferred embodiment of the method according to the invention, it is conceivable that the mark in step b. is a suitable encryption and that the mark and the coordinates of the suitable section are stored. This allows further narrowing down of the print jobs in question by means of the information contained in the encryption. In a particularly preferred manner, the encryption is binary and has a parity bit or a parity block. In this manner, errors during reading can be detected and/or corrected. The risks of finding a printing error and mistaking the printing error for a mark in the use described elsewhere are also minimized. The introduction of a binary encryption is made possible in a particularly simple manner by assigning an extreme value for the at least one characteristic property, as described elsewhere.

In an alternative embodiment of the method, the mark in step d. is localized. A localized mark is particularly inconspicuous and therefore disturbs the design of the printed-product raw template or the printed-product template to a particularly small extent. Since the mark itself does not carry any significant information content, it is further particularly preferred that when the mark and/or the coordinates are stored in step d., only the coordinates are stored. Nevertheless, it is still conceivable to additionally store the nature of the at least one characteristic property, the manifestation of the at least one characteristic property and/or the result of an analysis described elsewhere. Not storing the mark simplifies the storing of the remaining data, and the amount of data to be stored is reduced. To further simplify the method, it is also conceivable, either additionally or alternatively, that when the mark is created in step d., only the manifestation of the at least one characteristic property of the section is considered. In particular, the mark has no information value unlike in the case where the mark is an encryption. The tracing back to the print job in the use described elsewhere is only made via the coordinates of the mark and/or the nature of the mark or other parameters.

Furthermore, it is advantageous if the printed-product raw template in step a. is analyzed for at least one characteristic property and the result of the analysis is stored with reference to the print job, in particular in step a. or in step d.. Preferably, the printed-product raw template is analyzed for at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 characteristic properties. It is also conceivable that in the printed-product raw template in step a., a plurality of characteristic properties are first analyzed and, on the basis of the analysis, at least one characteristic property, preferably multiple characteristic properties, are selected for the further course of the method according to the invention, and in step a. or in step d., the nature and/or the manifestation of the selected characteristic property is stored. It is further conceivable to use the result of the analysis for making a preselection in the use described elsewhere. The analysis can comprise a frequency analysis, a statistical analysis of at least one characteristic property, in particular the calculation of at least one mean value, one mode, one median, one standard deviation, one absolute deviation, one skewness, one kurtosis, and/or one interquartile range, the formation of quantiles, the analysis of the frequency of occurrence and/or the distribution, the calculation of at least one center of gravity, the analysis, in particular the recognition, of designs, objects, edges, shapes and/or patterns and/or the mapping of two-dimensional space into one-dimensional space. Furthermore, it is conceivable that the analysis involves the calculation of at least one characteristic value from the results of one or more analysis methods, with the characteristic value being the result of the analysis.

It is to be assumed that the definitions and explanations of the above-mentioned terms apply to all aspects described in this description below, unless stated otherwise.

Furthermore, the invention proposes a use of a mark for tracing a printed product bearing the mark back to a print job, the mark being created by the method according to the invention, which comprises the steps listed elsewhere.

In the context of the invention, it has been recognized that a mark created by means of this method does not visually impair the design of the printed-product raw template, or only to a slight extent, while allowing the printed product to be easily traced back to a print job with the printed-product raw template.

In a preferred embodiment, the use comprises the following steps:
i. acquiring the printed product and/or creating a copy of the printed product;
ii. analyzing and/or assessing the printed product and/or the copy of the printed product for the at least one characteristic property and making a preselection by recalling at least one print job;
iii. checking the printed product or the copy of the printed product for the mark and
iv. selecting a sought print job from the preselection; and
v. tracing the printed product bearing the mark back to the sought print job.

In principle, the tracing back with the aid of the mark can take place in any manner. However, the previously shown use is a simple, fast and effective manner to reliably trace the printed product back to a print job.

The acquiring of the printed product and/or the creating of the copy of the printed product in step i. serves to provide or process the printed product in a manner that enables the analysis and/or the assessment in step ii. In a particularly preferred manner, the copy of the printed product is a high-resolution digital copy. This digital copy can preferably be created by scanning the printed product using a suitable scanner or by photographing the printed product using a suitable digital camera. When creating the copy of the printed product, it is also possible to enlarge it to make it easier to recognize possible marks.

The analyzing and/or assessing of the printed product and/or the copy of the printed product for the at least one characteristic property in step ii. can take place by optical inspection by a human, possibly supported by aids such as a magnifying glass. The analyzing is particularly easy and advantageous if a copy of the printed product is first created, which enlarges or enables an enlargement of the design of the printed product formed by the printed product template. If the copy of the printed product is created as a digital copy, it is also conceivable, in addition to or as an alternative to analyzing and/or assessing by a human being, to have the analysis and/or the assessment carried out, preferably automatically, by a computer system using suitable software. The analyzing is carried out analogously to the analyzing in step b. of the method according to the invention described elsewhere; i.e., the analysis is carried out analogously to the analysis of the method described elsewhere. This is logical since the use aims to find the print job according to which the present printed product has been produced. Preferably, a preselection of print jobs is made with the help of the result of the analysis and/or of the assessment by recalling all print jobs that are stored with reference to the result. The preselection accelerates the use since not all print jobs stored have to be checked in the further course of the use, but only those of the preselection. This applies in particular if the preselection contains only a small number of print jobs (hits). It is also conceivable that the preselection contains only a single hit. The use can then serve to validate the single hit. The nature of recalling depends on how the print jobs are stored. If the print jobs are stored in a database, recalling means formulating a corresponding search query. It should be noted here that certain deviations may occur when determining the recall parameters. These deviations are due to technical reasons and/or the manual process. Therefore, the recall should also consider print jobs for which the stored parameters are similar to the recall parameters. In particular, similar parameters include parameters that lie within the tolerance range determined by the technical and/or manual process. This is known to a person skilled in the art, as are methods and procedures for determining the tolerance range.

In step iii. the printed product or the copy of the printed product is checked for the mark. That is, it is checked at which coordinates a mark is present. If the mark is present, the coordinates and/or the mark itself are identified and/or recorded. As in step ii., the check can be carried out by a human, possibly with the help of aids, and/or by a suitable computer system running suitable software. Subsequently, a print job from the preselection is selected. Logically, this is the print job for which the mark and/or the coordinates stored with reference to the print job match the mark and/or the coordinates of the printed product or of the copy of the printed product. In addition, further information, such as the person that ordered the printed product, the nature of the printed product, the degree of deviation of the coordinates and/or the mark and/or stored keywords regarding the print job that describe the design, can also be taken into consideration in the selection. Even if multiple printed products receive the same mark and/or the same coordinates, the selection from a significantly reduced number of recalled print jobs for tracing is simplified considerably.

In step iv, the printed product bearing the mark is traced back to the sought print job. In this manner, it is now obvious to the user performing the use to which print job the printed product at hand belongs. The tracing back can be carried out for any reason; it is conceivable that the use takes place in the context of a (routine) inspection, a new order, a subsequent order, an order from a different contractor with reference to the printed product, or in the context of a product recall for damaged, defective, or missing printed products. During use, it has also been recognized that the downscaling from all print jobs stored to the recalled print jobs by means of the mark is already very advantageous.

The preselection can basically be made in any manner. However, it has been found in practice that some particularly preferred methods, which can be executed individually or in combination, achieve particularly good results. This means that the sought print job is included in the preselection with a sufficiently high probability, and the preselection has a sufficiently low number of hits. In a first preferred embodiment, the preselection in step ii. is made by recalling all print jobs with reference to printed-product raw templates and/or printed-product templates that are sufficiently similar, in particular identical, to the printed product or the copy of the printed product. The similarity and/or identity can be determined by comparing the printed product or the copy of the printed product with the printed-product raw template stored with reference to the print job and/or with the printed-product template stored with reference to the print job. This is a very fast and reliable manner of obtaining a suitable preselection. The comparison can be carried out by a computer system using suitable software. The similarity takes into account the deviations caused elsewhere due to technical reasons and/or the manual process. Furthermore, recalling can be accelerated by expanding the similarity. This means the further the interpretation of the term “similar”, the faster the comparison, but the greater the number of hits of the preselection.

In a second preferred embodiment, the printed product and/or the copy of the printed product are analyzed and/or assessed for at least two characteristic properties in step ii., at least one of the characteristic properties being selected, and furthermore, the preselection is made by recalling all print jobs with reference to the nature and/or the manifestation of the selected characteristic property. In this context, it is logical that the nature and/or manifestation of the selected characteristic property has been stored accordingly in the method according to the invention, as described elsewhere. It is also logical that the same rule for selecting at least one characteristic property is used for the use according to the invention as in the method described elsewhere.

In a third preferred embodiment, the preselection in step ii. is made by recalling all print jobs with reference to the result of the analysis. It is logical in this context that in the method according to the invention, the analysis for the at least one characteristic property has been carried out accordingly and the result has been stored with reference to the print job, as described elsewhere. It is also logical that the same analysis is carried out for the use according to the invention as for the method described elsewhere in order to obtain the same result. The analysis can also be carried out for a plurality of characteristic properties and, on the basis of the analysis, at least one characteristic property, preferably multiple characteristic properties, can be selected for the further course of the use according to the invention.

Moreover, it is conceivable that the checking in step iii. is carried out by analyzing the section with the coordinates stored with reference to the print job of the preselection for the presence of the mark, the selecting relating to the print job in which the mark is present. It has been found that the preselection is usually limited to such a small number of print jobs that it is faster to check all the sections whose coordinates are stored in one of the print jobs of the preselection than to determine the suitable sections, check them for the mark, identify the coordinates of the sections with the mark and then compare these coordinates with the coordinates stored with reference to the print jobs of the preselection. This is because analyzing all sections of the printed product and/or the copy of the printed product is not necessary.

The invention further proposes a marked printed product obtained by the method according to the invention, which comprises the steps listed elsewhere.

In particular, the printed product is a paper product, an advertising medium, a promotional item, a textile, a sticker and/or packaging.

Paper products are understood to be products that are made of paper. The term “paper product” comprises, in particular, but not exclusively, a newspaper, a magazine, a (writing) pad, a letterhead, an envelope, a brochure, a book, a leaflet, a flyer, a card, in particular a menu card, a greeting card and a postcard, a plan, a calendar, a catalog, a poster, a banner, a flysheet, a hanging label, a tag, in particular a door hanger, a suitcase tag and a bottle tag, and/or a business card.

Advertising material is understood to mean goods that serve advertising, decoration and/or information purposes. The term “advertising material” comprises, in particular, but by no means exclusively, a flag, a streamer, a banner, an adhesive film, an illuminated advertisement, a trade fair stand, a pavilion, a parasol, a tarp, a brochure holder, a frame system, a sign, a partition, a deck chair, an advertising banner, an advertising display, in particular a customer stopper, a barrier tape and an advertising pillar.

Promotional items are understood to be small items that are usually given to people, in particular customers, for advertising purposes. The term “promotional items” comprises, in particular, but by no means exclusively, an ice scraper, a license plate holder, a parking disk, a magnet, a mark clip, a mouse pad, a loudspeaker, a power bank, a USB stick, a bottle, a balloon, a bicycle saddle cover, sunglasses, a mask, a mug, a glass, a cup, a can, a pen, a pen holder, an eraser, an umbrella, a button, a key fob, a bag, a plastic bag, a tape measure, a spirit level, a pocket knife and a folding rule.

The term “textiles” refers to goods made from a fabric. The term “textiles” comprises, in particular, but by no means exclusively, work clothes, a cape, a cloth, in particular a shawl, a neckerchief, a towel, a bath towel and a cleaning cloth, trousers, a skirt, a dress, underwear, swimwear, a shirt, a blouse, a jacket, a vest, such as a high-visibility vest, headwear, such as a hat and a cap, in particular a beanie and a peaked cap, a polo shirt, a T-shirt, an apron, sportswear, such as a jersey, a sweatshirt, a sweater, a patch, a badge and a scarf.

Stickers comprise, in particular, an adhesive label, a tag, an adhesive tape and a post-it note.

Packaging is understood to mean means for packaging goods, in particular for transportation. The term “packaging” comprises, in particular, but by no means exclusively, a package, a mailing bag, a hinged-lid box, a tissue paper, a packaging bag, a folding box, gift wrapping paper, a box and a basket.

Further details, features and advantages of the invention will become apparent from the following description of the preferred exemplary embodiments in conjunction with the dependent claims. For this purpose, the respective features can be realized individually or in combination with each other. The invention is not limited to the exemplary embodiments. The exemplary embodiments are schematically illustrated in the figures. Identical reference signs in the individual figures denote identical elements or elements having the same function or a mutually corresponding function.

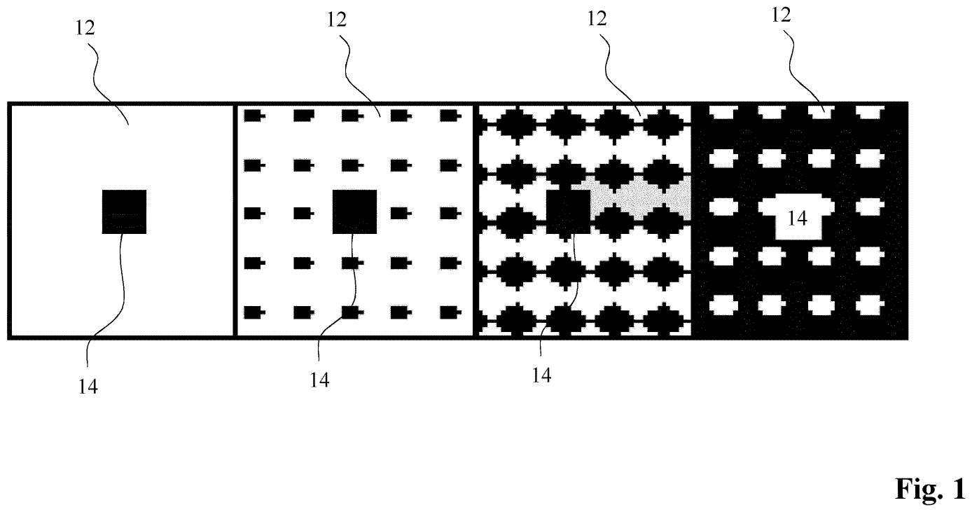

FIG. 1 shows an embodiment according to the invention with marks in selected sections of a printed-product template;

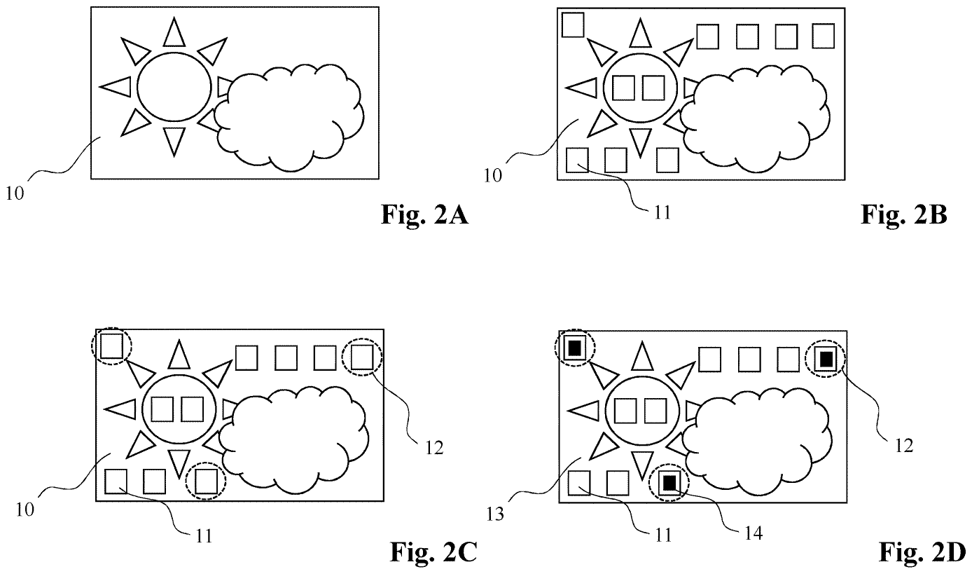

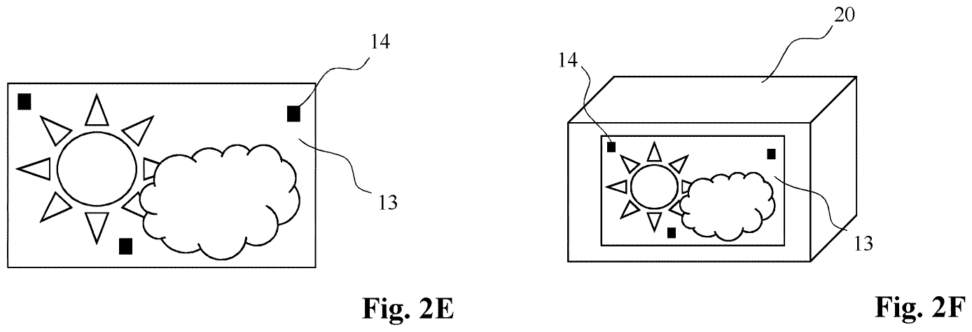

FIGS. 2A to 2F show an embodiment of the method according to the invention;

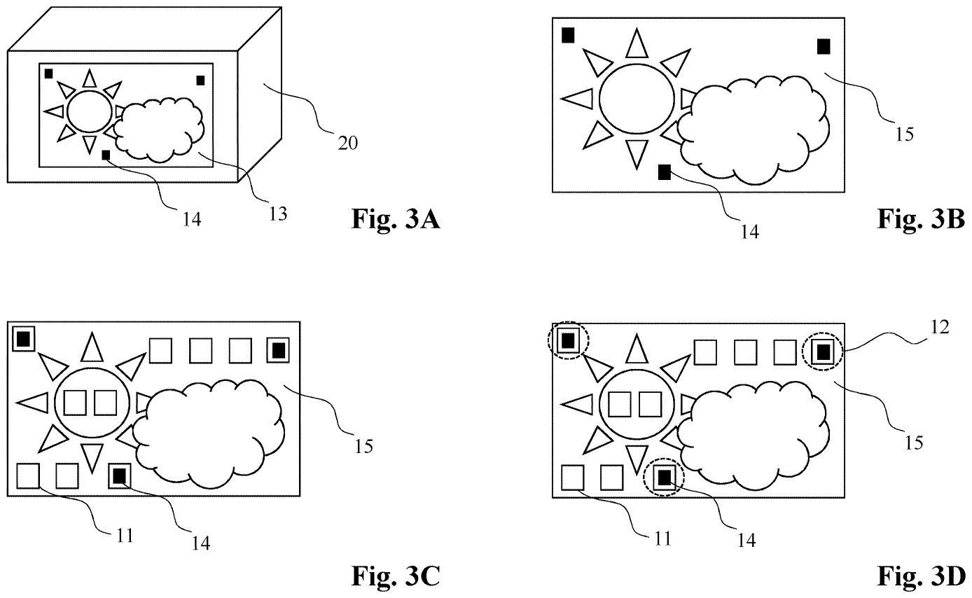

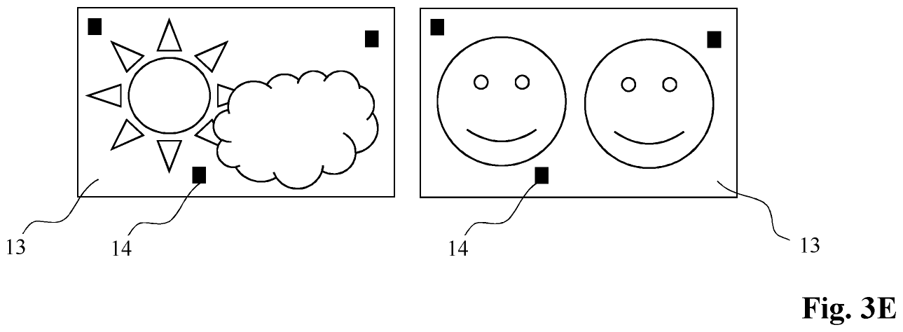

FIGS. 3A to 3E show an embodiment of the use according to the invention.

FIG. 1 shows an according-to-the-invention embodiment of four marks 14, which have been introduced, respectively, in four selected sections 12 by modulation. It should be noted that the selected sections 12 and the marks 14 in FIG. 1 are shown greatly enlarged. The black dots formed in the three selected sections 12 on the right represent any color, for example the color yellow. The monochromaticity in the color yellow is the characteristic property that has characterized the selected sections 12 as sections that are suitable in principle. The larger the dots, the more intense the appearance of the color. As can be seen, the suitable sections are characterized by the fact that the dots are approximately the same size and formed at approximately the same distance. That is, the dots are limited in their maximum deviation from a mean value. This corresponds to a monochromatic design. The characteristic property of the suitable sections is therefore characterized by its monochromaticity. The marks 14 were created in consideration of the manifestation of the characteristic property. So the three marks 14 on the left, whose selected sections 12 each have a value of less than 50 of the color yellow in the CYMK color model, were created by assigning them the extreme value 100. In the case of the suitable section 12 on the far right, on the other hand, the value of the color yellow is over 50, meaning the mark 14 has been created by assigning the extreme value 0. It is therefore clearly recognizable that the marks 14 stand out clearly from the given manifestation of the characteristic property.

The sequence of FIGS. 2A to 2F shows an embodiment of the method according to the invention. FIG. 2A shows a printed-product raw template 10. The design of the printed-product raw template 10 is a sun and a cloud against a sky. If the printed-product raw template were colored, the sun would be yellow and the background of the design would be blue. The cloud does not have a uniform color, but rather portions of yellow and white. FIG. 2B shows the result of an analysis for at least one characteristic property, where the characteristic property in this case is monochromaticity. The analysis for the characteristic property revealed a total of ten suitable sections 11 in the printed-product raw template 10. The suitable sections 11 are marked with rectangles, only one rectangle having been marked with the reference number for the sake of clarity. The suitable sections 11 are characterized by their manifestation of the characteristic property, which is monochromaticity. Hence, the deviation from a mean value in the suitable sections 11 is limited across the entire area of the suitable section 11. This means that a mean value of the color can be formed via the hue as well as via the saturation and the value (brightness) in the suitable sections 11, and in no dot is the deviation greater than a previously set limit. It should be noted that the suitable sections 11 are usually significantly smaller in relation to the printed-product raw template 10 than shown in FIG. 2B. The greatly enlarged illustration serves only to clarify the method according to the invention. The suitable section 11 is preferably about 500 μm in size. In FIG. 2C, three of the ten suitable sections 11 have been selected and form the selected sections 12. The three selected sections 12 are marked with a dashed circle, only one selected section 12 being marked with a reference sign for the sake of clarity. The selection of the selected sections 12 was random. In FIG. 2D, a mark 14 was introduced into the selected sections 12 in consideration of the manifestation of the characteristic property. The mark 14 is an assignment of an extreme value of the manifestation of the characteristic property. It should further be noted that the mark 14 is also shown greatly enlarged and, for the sake of clarity, only one mark 14 has been marked with a reference sign. Preferably, the mark 14 has an extent of no more than 100 μm. Furthermore, the coordinates of the selected sections 12 are stored in a database. It is also conceivable to store the nature of the characteristic property, in this case a monochromatic hue, and the manifestation of the characteristic property, in this case the color blue. By means of the modulation for the introduction of the mark 14, the printed-product template 13 is now shown in FIG. 2D. FIG. 2E shows the finished printed-product template 13 with the three marks 14. The rectangles and circles that have marked the suitable sections 11 and the selected sections 12 have been removed. FIG. 2F shows the printed product 20 to which the printed-product template 13 with the marks 14 has been applied. In the present example, the printed product 20 is an eraser.

The sequence of FIGS. 3A to 3E shows a use of a mark 14 according to the invention, the mark 14 having been produced using a method according to the invention. FIG. 3A shows the printed product as already depicted in FIG. 2F. The printed product 20 also has the printed-product template 13 with the mark 14 printed on it. In FIG. 3B, a printed-product copy 15 of the printed-product template 13, which has been printed on the printed product 20, can be seen. Preferably, the copy 15 of the printed product is enlarged so that the marks 14 can be found more easily during use. In the sequence of FIGS. 3A to 3E, the marks 14 are also shown greatly enlarged. In the next step of the use, the copy 15 of the printed product is analyzed for at least one characteristic property. The analysis shows that a monochromatic hue is particularly suitable as a characteristic property. Hence, a preselection of print jobs for which the nature of the characteristic property has been stored as “monochromatic” or “hue” is made. Subsequently, it is conceivable that an analysis analogous to the analyzing of the method according to the invention as shown in FIGS. 2A to 2F is carried out, in which the same suitable sections 11 are also found, in order to compare the coordinates with those of the print jobs of the preselection. In practice, however, it is easier and quicker to check all suitable sections 11 for the mark 14 whose coordinates have been stored with reference to a print job of the preselection in the next step. FIG. 3D shows that a mark 14 has been found in three of the suitable sections 11 and that they have been identified as the selected sections 12. In the next step, all print jobs of the preselection that have been stored with reference to these coordinates or similar coordinates of the selected sections 12 are recalled. Depending on the number of marks, it is conceivable that the same or similar coordinates have been stored for multiple print jobs. In the case at hand, two suitable print jobs of the preselection are found and recalled, which have the printed-product templates 13 shown in FIG. 3E and stored with reference to the print jobs. Thus, the use has reduced the number of potential print jobs from a large number to two. Subsequently, a further selection of the sought print job takes place. This can be done, for example, by matching the printed-product templates 13 with the copy 15 of the printed product or the printed product 20. Such a comparison would show that the print job stored with reference to the printed-product template 13 on the left is the sought print job. Another conceivable matching option would be to compare the mark 14. In the case of the printed-product template 13 on the left, the marks 14 are all an extreme value of the color blue. It is conceivable that the background of the right printed-product template 13 is magenta. In this case, the mark 14 would be an extreme value of the color magenta. If the mark 14 is also stored, a comparison of the mark 14 would identify the print job as the sought print job that was stored with reference to the printed-product template 13 on the left. In the sequence of FIGS. 3A to 3E, one mark 14, one selected section 12 and one suitable section 11 have been provided with a reference sign in each case for the sake of clarity.

1. A method for marking a printed product (20) with a mark (14), the method comprising the following steps:
a. acquiring a printed-product raw template (10);
b. analyzing the printed-product raw template (10) for at least one characteristic property of the printed-product raw template (10) to determine at least one suitable section (11), the at least one characteristic property having a nature and a manifestation;
c. selecting at least one suitable section (11) and identifying coordinates of the selected section (12);
d. creating a mark (14) in consideration of the manifestation of the at least one characteristic property in the selected section (12) and storing the nature of the at least one characteristic property, the manifestation of the at least one characteristic property, the mark (14), and/or the coordinates of the selected section (12) with reference to a print job;
e. producing a printed-product template (13) by modulating the selected section (12) of the printed-product raw template (10) as a function of the mark (14); and
f. producing and obtaining a printed product (20) according to the printed-product template (13).

2. The method according to claim 1,
wherein the nature of the at least one characteristic property is monochromaticity, hue, value (brightness), saturation, regularity, pixel density, potential dot density, frequency space and/or contrast.

3. The method according to claim 1 or 2,
wherein the suitability of the suitable section (11) in step b. is reflected by a limitation of a maximum deviation of the manifestation of the at least one characteristic property from a mean value of the manifestation of the at least one characteristic property across the entire area of the suitable section (11).

4. The method according to any one of the preceding claims,
wherein the selection in step c. is random or follows a rule.

5. The method according to any one of the preceding claims,
wherein 2 to 40 suitable sections (11) are selected in step c..

6. The method according to any one of the preceding claims,
wherein the mark (14) is selected in such a manner in step d. that its extent on the printed product (20) is no more than 200 μm, in particular no more than 100 μm.

7. The method according to any one of the preceding claims,
wherein the mark (14) is created in step d. by inverting the manifestation of the at least one characteristic property at least in a localized manner.

8. The method according to any one of claims 1 to 6,
wherein the mark (14) in step d. is created by assigning an extreme value of the at least one characteristic property at least in a localized manner.

9. The method according to any one of the preceding claims,
wherein the mark (14) in step d. is a suitable encryption and wherein the mark (14) and the coordinates are stored when storing the mark (14) and/or the coordinates in step d..

10. The method according to claim 9,
wherein the encryption is binary and comprises a parity bit or a parity block.

11. The method according to any one of claims 1 to 8,
wherein the mark (14) in step d. is localized.

12. The method according to claim 11,
wherein only the coordinates are stored when storing the mark (14) and/or the coordinates in step d..

13. The method according to claim 11 or 12,
wherein only the manifestation of the at least one characteristic property of the selected section (12) is considered when creating the mark (14) in step d..

14. The method according to any one of the preceding claims,
wherein the printed-product raw template (10) is analyzed for at least one characteristic property in step a., and the result of the analysis is stored with reference to the print job, in particular in step a. or in step d..

15. Use of a mark (14) for tracing a printed product bearing the mark (14) back to a print job, the mark (14) being created by the method according to any one of claims 1 to 14.

16. The use of a mark (14) according to claim 15, wherein the use comprises the following steps:
i. acquiring the printed product (20) and/or creating a copy (15) of the printed product;
ii. analyzing and/or assessing the printed product (20) and/or the copy (15) of the printed product for the at least one characteristic property and making a preselection by recalling at least one print job;
iii. checking the printed product (20) or the copy (15) of the printed product for the mark (14) and selecting a sought print job from the preselection; and
iv. tracing the printed product (20) bearing the mark (14) back to the sought print job.

17. The use of a mark (14) according to claim 16;
wherein the preselection in step ii. is made by recalling all print jobs with reference to printed-product raw templates (10) and/or printed-product templates that are similar, in particular identical, to the printed product (20) or the copy (15) of the printed product.

18. The use of a mark (14) according to claim 16 or 17;
wherein, in step ii., the printed product (20) and/or the copy (15) of the printed product is analyzed and/or assessed for at least two characteristic properties, at least one of the characteristic properties being selected, and
wherein the preselection in step ii. is made by recalling all print jobs with reference to the nature and/or the manifestation of the selected property.

19. The use of a mark (14) according to any one of claims 16 to 18;
wherein the preselection in step ii. is made by recalling all print jobs with reference to the result of the analysis.

20. The use of a mark (14) according to any one of claims 16 to 19;
wherein the checking in step iii. takes place by analyzing the section with the coordinates stored with reference to the print job or the print jobs of the preselection for the presence of the mark, and
wherein the selection in step iii. relates to the print job where the mark is present.

21. A marked printed product (20) obtained by the method according to any one of claims 1 to 14.
